(19) United States
(12) Patent Application Publication
(10) Pub. No.: US 2026/0281913 A1
(43) Pub. Date: Sep. 17, 2026

(54) DETERMINING PRACH SPATIAL TX FILTER AND TX POWER IN MULTI-TRP TRANSMISSIONS

(71) Applicant: Telefonaktiebolaget LM Ericsson (publ), Stockholm (SE)

(72) Inventors: Shiwei Gao, Nepean, Ontario (CA); Siva Muruganathan, Stittsville, Ontario (CA); Helka-Liina Määttanen, Espoo (FI); Jianwei Zhang, Solna (SE); Claes Tidestav, Bålsta (SE)

(21) Appl. No.: 19/156,984

(22) PCT Filed: Feb. 16, 2024
(86) PCT No.: PCT/IB2024/051502

§ 371 Date: Aug. 15, 2025

Related U.S. Application Data
(60) Provisional application No. 63/485,699, filed on Feb. 17, 2023.

(51) Int. Cl. H04W 52/32; H04L 5/00; H04W 56/00; H04W 72/232; H04W 74/0833

(52) U.S. Cl. CPC H04W 52/325; H04L 5/0053; H04W 56/0045; H04W 72/232; H04W 74/0833

(57) ABSTRACT

Systems and methods are disclosed for determining a transmit power for Physical Random Access Channel (PRACH) for a multi-Transmission and Reception Point (TRP) transmission. In one embodiment, a method performed by a User Equipment (UE) comprises receiving a configuration of a first and second time advance group (TAG) identity (ID), a first control resource set (CORESET) with a first CORESET pool index value, and a second CORESET with a second CORESET pool index value in a serving cell. The method further comprises receiving a request in the serving cell to transmit a Physical Random Access Channel (PRACH) preamble, the request comprising a PRACH preamble index, information about a downlink reference signal (RS), and information about a Physical Cell Identity (PCI) associated with the downlink RS. The method further comprises determining, based on the request, a transmit power for transmission of the PRACH preamble, and transmitting the PRACH preamble accordingly.

### RELATED APPLICATIONS

This application claims the benefit of provisional patent application Ser. No. 63/485,699, filed Feb. 17, 2023, the disclosure of which is hereby incorporated herein by reference in its entirety.

### TECHNICAL FIELD

The present disclosure relates to a cellular communications system and, more particularly, to Physical Random Access Channel (PRACH) transmission.

### BACKGROUND

Third Generation Partnership Project (3GPP) New Radio (NR) uses Cyclic Prefix Orthogonal Frequency Division Multiplexing (CP-OFDM) in both downlink (DL) (i.e., from a network node, gNodeB, or base station, to a User Equipment or UE) and uplink (UL) (i.e., from UE to gNodeB). Discrete Fourier Transform (DFT) spread Orthogonal Frequency Division Multiplexing (OFDM) is also supported in the uplink. In the time domain, NR downlink and uplink are organized into equally sized subframes of 1 millisecond (ms) each. A subframe is further divided into multiple slots of equal duration. The slot length depends on subcarrier spacing. For subcarrier spacing of Δf=15 kilohertz (kHz), there is only one slot per subframe, and each slot consists of 14 OFDM symbols.

Data scheduling in NR is typically in slot basis, an example is shown in FIG. 1A with a 14-symbol slot, where the first two symbols contain physical downlink control channel (i.e., Physical Downlink Control Channel (PDCCH)) and the rest contains physical shared data channel, i.e., either Physical Downlink Shared Channel (PDSCH) or Physical Uplink Shared Channel (PUSCH).

Different subcarrier spacing (SCS) values are supported in NR. The supported SCS values (also referred to as different numerologies) are given by Δf=(15×2^{μ}) kHz where u E {0,1,2,3,4}. Δf=15 kHz is the basic subcarrier spacing. The slot duration for a given subcarrier spacing is

$$\frac{1}{{2}^{μ}} ms .$$

In the frequency domain, a system bandwidth is divided into Resource Blocks (RBs), each corresponding to twelve (12) contiguous subcarriers. The RBs are numbered starting with 0 from one end of the system bandwidth. The basic NR physical time-frequency resource grid is illustrated in FIG. 1B, where only one RB within a 14-symbol slot is shown. One OFDM subcarrier during one OFDM symbol interval forms one Resource Element (RE).

Downlink transmissions to a UE can be dynamically scheduled by sending Downlink Control Information (DCI) with a downlink (DL) DCI format carried on PDCCH. The UE first detects and decodes PDCCH and, if the decoding is successful, the UE then decodes the corresponding PDSCH according to the scheduling information in the DCI.

Similarly, uplink data transmission can be dynamically scheduled using an uplink (UL) DCI format carried on PDCCH. A UE first decodes uplink grants in the DCI and then transmits data over Physical Uplink Shared Channel (PUSCH) according to the control information contained in the uplink grant.

### 1 CORESET and Search Space Set

A Control Resource Set (CORESET) consists of a number of RBs in frequency domain and one to three consecutive OFDM symbols in time domain. In NR Release 15, a UE can be configured with up to three (3) CORESETs per Bandwidth Part (BWP).

A set of PDCCH candidates is defined in a PDCCH Search Space (SS) set associated to a CORESET. A UE monitors the set of PDCCH candidates for detecting PDCCHs. A SS set can be a Common Search Space (CSS) set or a UE Specific Search Space (USS) set. A UE can be configured with up to ten (10) SS sets per BWP for monitoring PDCCH candidates.

### 2 TCI States and QCL

A Transmission Configuration Indicator (TCI) state for a CORESET contains Quasi Co-location (QCL) information between a Demodulation Reference Signal (DMRS) of PDCCH transmitted in the CORESET and one or two DL Reference Signals (RSs) such as a Channel State Information Reference Signal (CSI-RS) or a Synchronization Signal and Physical Broadcast Channel Block (SSB). Two antenna ports are said to be QCL if certain channel parameters associated with one of the two antenna ports can be inferred from the other antenna port. The supported QCL information types in NR include:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For each CORESET, a list of TCI states can be Radio Resource Control (RRC) configured, one of the TCI states is activated by a Medium Access Control (MAC) Control Element (CE). For example, if a SSB is configured as the QCL-typeD source RS in an activated TCI state for a CORESET, the same receive beam for receiving the SSB can be used by a UE to receive PDCCHs transmitted in the CORESET.

In NR Rel-17, a unified TCI state framework was introduced in which multiple common TCI states may be activated by a MAC CE, and one of the activated TCI states is indicated by a DCI for multiple DL and/or UL channels or signals. In this case, a CORESET may follow the indicated common TCI state.

### 3 SSB

A Physical Broadcast Channel (PBCH), Primary Synchronization Signal (PSS), and Secondary Synchronization Signal (SSS) are in consecutive OFDM symbols, as defined in 3GPP TS 38.211, and form a SS/PBCH block or SSB in short. Multiple SSBs, or a SSB burst set, can be configured within each half radio frame, or 5 ms. A SSB burst set is transmitted periodically in multiple of 5 ms. The maximum number, L, of SSBs in a SSB burst set is carrier frequency dependent, where L=4 for carrier frequency up to 3 GHZ, L=8 for carrier frequency between 3 GHz and 6 GHz, and L=64 for carrier frequency from 6 GHz to 52.6 GHz. SSBs are indexed from 0 to L−1 in increasing order within a half radio frame. A same transmit power is used for all SSB transmissions in a cell.

SSB is used for a UE to acquire time and frequency synchronization with a cell and to detect the physical layer Cell Identity (ID) of the cell.

The information about SSBs and physical layer Cell ID would typically be acquired by a UE from SSB, MIB (Master Information Block) in PBCH or SIBs (System Information Blocks) in PDSCH when accessing the cell from IDLE. In case of configuring a UE with a Secondary Cell(s) (SCell(s)), or with an additional Secondary Cell Group (SCG), or reconfiguring of Special Cells (SpCells) (MCG (master cell group) and SCG (secondary cell group), SSBs for a cell may be configured by ServingCellConfigCommon information element (IE) shown in FIG. 2 via dedicated signaling.

### 4 Physical Random Access Procedure

Prior to initiation of the physical random access procedure, Layer 1 or physical layer receives from higher layers a set of SSB indexes and provides to higher layers a corresponding set of Reference Signal Received Power (RSRP) measurements.

Physical random access procedure is triggered upon request of a Physical Random Access Channel (PRACH) transmission by higher layers or by a PDCCH order. A configuration by higher layers for a PRACH transmission includes the following:
A configuration for PRACH transmission according to 3GPP TS 38.211 (see, e.g., v17.4.0)
A preamble index, a preamble SCS, PRACH target receive power, a corresponding RA-RNTI (RACH radio network temporary identifier), and a PRACH resource.

A PRACH preamble is transmitted according to the PRACH configuration with a transmission power on the indicated PRACH resource.

PRACH configuration can be cell specific or UE specific. Cell specific PRACH configuration is via a RACH-ConfigCommon information element (IE) while UE specific PRACH configuration is done via a RACH-ConfigDedicated IE, both are described in 3GPP TS 38.331.

For Type-1 (or 4-step) random access procedure, a UE is provided with a total number,

$${N}_{preamble}^{total} ,$$

of PRACH preambles for both Contention-Based Random Access (CBRA) and Contention-Free Random Access (CFRA) in each PRACH occasion. The default is

$${N}_{preamble}^{total} = 64$$

if it is not configured. The UE is also provided a number N of SSB indexes associated with one PRACH occasion and a number R of contention based preambles per SSB index per valid PRACH occasion by a parameter called ssb-perRACH-OccasionAndCB-PreamblesPerSSB contained in RACH-ConfigCommon IE.

If N<1, one SSB index is mapped to 1/N consecutive valid PRACH occasions and R contention based preambles with consecutive indexes associated with the SSB index per valid PRACH occasion start from preamble index 0. An example is shown in FIG. 3A, where N=½, R=32,

$${N}_{preamble}^{total} = 64 ,$$

### and 4 SSDS.

If N≥1, R contention based preambles with consecutive indexes associated with SSB index n, 0≤n≤N−1, per valid PRACH occasion start from preamble index

$$n \cdot {N}_{preamble}^{total} / N .$$

An example is shown in FIG. 3B, where N=4, R=4,

$${N}_{preamble}^{total} = 64 ,$$

and 4 SSBs. In this example, for each PRACH occasion PRACH preambles 0 to 3 are allocated to SSB #0 for CBRA and PRACH preambles 4 to 5 are allocated to SSB #0 for CFRA, PRACH preambles 16 to 19 are allocated to SSB #1 for CBRA and PRACH preambles 20 to 31 are allocated to SSB #1 for CFRA, and so on.

Association of CFRA preambles with SSBs can also be reconfigured via a higher parameter ssb-perRACH-Occasion in RACH-ConfigDedicated IE, in which the UE is provided with information about a number N of SS/PBCH block indexes associated with one PRACH occasion. The UE may also provide information about a mapping between a SSB index or a CSI-RS resource and a preamble index in a PRACH occasion.

### 5 PDCCH Order Initiated Random Access Procedure

A random access procedure can be initiated by either the gNodeB or the UE. A random access procedure can be initiated by a PDCCH order sent from the gNodeB to the UE for synchronizing the UL when UL time alignment may have been lost. PDCCH order is carried by DCI format 1-0 when the DCI's Cyclic Redundancy Check (CRC) is scrambled by a UE's C-RNTI (Cell Radio Network Temporary Identifier) and the “Frequency domain resource assignment” field of the DCI contains all ones. The PDCCH order contains the following information:
Random Access Preamble index: 6 bits according to a higher layer parameter “ra-PreambleIndex” in Clause 5.1.2 of 3GPP TS 38.321 (see, e.g., v17.3.0)
SS/PBCH index: 6 bits, If the value of the “Random Access Preamble index” is not all zeros, this field indicates the SS/PBCH that shall be used to determine a RACH (random access channel) occasion for PRACH (Physical random access channel) transmission; otherwise, this field is reserved.
PRACH Mask index. If the value of the “Random Access Preamble index” is not all zeros, this field indicates the RACH occasion associated with the SS/PBCH indicated by “SS/PBCH index” for the PRACH transmission, according to Clause 5.1.1 of 3GPP TS 38.321; otherwise, this field is reserved

If the PRACH preamble index is non-zero, a contention free random access (CFRA) procedure is triggered, in which the PRACH preamble is allocated only for the UE in a corresponding PRACH resource. I

If the PRACH preamble index is zero, and CFRA PRACH resources associated with SSBs have been provided in a UE specific PRACH configuration in rach-ConfigDedicated IE, UE first select an SSB with SS-RSRP (SSB based Reference Signal Received Power) above a configured threshold, then select a PRACH preamble according to the selected SSB. If the PRACH preamble index is zero, and CFRA resources associated with CSI-RSs have been provided in rach-ConfigDedicated IE, UE first select an CSI-RS with CSI-RSRP above a configured threshold, rsrp-ThresholdCSI-RS, then select a PRACH preamble according to the selected CSI-RS. If the PRACH preamble index is zero and the CFRA PRACH resources associated with SSB or CSI-RS are not provided, a contention-based random access (CBRA) procedure is triggered by the PDCCH order, in which the UE selects a PRACH preamble randomly from a set of PRACH preambles configured for CBRA in the serving cell. Note that in this case, the same preamble could be selected by more than one UE in a same PRACH resource and contention could occur. PDCCH order triggered CBRA is only allowed for a SpCell, i.e., a primary cell in either a master cell group (MCG) or a secondary cell group (SCG), if cell groups are configured. The rach-ConfigDedicated IE is described in 3gpp TS38.331, the detailed procedure is described in 3GP TS38.321 section 5.1.2.

If a UE is configured with two UL carriers for a serving cell and the UE detects a PDCCH order, the UE uses the UL/SUL indicator field value from the detected PDCCH order to determine the UL carrier for the corresponding PRACH transmission.

A PRACH occasion is a time and frequency resource (i.e., a number of RBs in a number of OFDM symbols) allocated for PRACH transmission, multiple PRACH occasions may be configured in a PRACH configuration period consisting multiple radio frames. PRACH occasions may be multiplexed either in time or frequency.

From the physical layer perspective, the random access procedure triggered by a PDCCH order includes the transmission of random access preamble (Msg1) in a PRACH by a UE, the transmission of RAR (random access response) message with a PDCCH and a corresponding PDSCH (Msg2), and when applicable, the transmission of a PUSCH scheduled by a RAR UL grant, and PDSCH for contention resolution if the RACH procedure is contention based.

### 6 PRACH Power Control

According to 3GPP TS 38.213 (see, e.g., v17.4.0), a UE determines a transmission power for a PRACH, P_{PRACH,b,f,c} (i), on active UL BWP b of carrier f of serving cell c based on DL reference Signal (RS) for serving cell c in transmission occasion i as

$${P}_{PRACH , b , f , c} ( i ) = min \{ {P}_{CMAX , f , c} ( i ) , {P}_{PRACH , target , f , c} + {PL}_{b , f , c} \} [ dBm ]$$

where P_{CMAX,f,c} (i) is the UE configured maximum output power defined in 3GPP TS 38.101-1 (see, e.g., v17.8.0), TS 38.101-2 (see, e.g., v17.8.0), and TS 38.101-3 (see, e.g., v17.8.0) for carrier f of serving cell c within transmission occasion i, P_{PRACH,target,f,c} is the PRACH target reception power provided by higher layers described in TS 38.321 (see, e.g., v17.3.0) for the active UL BWP b of carrier f of serving cell c, and PL_{b,f,c} is a pathloss for the active UL BWP b of carrier f based on the DL RS associated with the PRACH transmission on the active DL BWP of serving cell c and calculated by the UE in dB as

$${PL}_{b , f , c} = referenceSignalPower - higher layer filtered RSRP [ dB ] ,$$

where RSRP is defined in 3GPP TS 38.215 (see, e.g., v17.2.0) and the higher layer filter configuration is defined in TS 38.331. If the active DL BWP is the initial DL BWP and for SS/PBCH block and CORESET multiplexing pattern 2 or 3, as described in clause 13 of TS38.213, the UE determines PL_{b,f,c} based on the SS/PBCH block associated with the PRACH transmission.

If a PRACH transmission from a UE is in response to a detection of a PDCCH order by the UE that triggers a CBRA procedure, referenceSignalPower is provided by a higher layer parameter “ss-PBCH-BlockPower”.

If a PRACH transmission from a UE is in response to a detection of a PDCCH order by the UE that triggers a CFRA procedure and depending on the DL RS that the DM-RS of the PDCCH order is quasi-collocated with as described in clause 10.1 of 38.213, referenceSignalPower is provided by “ss-PBCH-BlockPower” or, if the UE is configured resources for a periodic CSI-RS reception as described in clause 6 of 38.213, referenceSignalPower is obtained by “ss-PBCH-BlockPower” and “powerControlOffsetSS” where powerControlOffsetSS provides an offset of CSI-RS transmission power relative to SS/PBCH block transmission power as described in TS 38.214. If the active TCI state for the PDCCH that provides the PDCCH order includes two RS, the UE expects that one RS is configured with qcl-Type set to ‘typeD’ and if the one RS is a SSB, then referenceSignalPower is provided by ss-PBCH-BlockPower, otherwise, if the one RS is a CSI-RS, referenceSignalPower is obtained by ss-PBCH-BlockPower and powerControlOffsetSS. If powerControlOffsetSS is not provided to the UE, the UE assumes an offset of 0 dB.

### 7 UL Time Alignment in NR

Different UEs in a serving cell may be located at different positions within the cell and, thus, different distances to the base station (e.g., NR gNodeB). If all UEs transmit to gNodeB at a same time instance, transmissions from different UEs may reach gNodeB at different time instances. If the time instances are outside a certain reception time window, the UEs will interfere with each other resulting in demodulation difficulties at the gNodeB. In order to make sure that the Uplink (UL) transmissions from a UE reaches the base station within the reception window, an uplink timing alignment procedure is therefore used.

Time alignment of the uplink transmissions is achieved by applying a timing advance at the UE transmitter, relative to the received downlink timing. The main role of this is to counteract different propagation delays between different UEs.

In order to achieve the time alignment between different UEs, the base station (e.g. gNodeB, eNodeB) derives and signals a required Timing Advance (TA) value for each UE to apply to the UL transmissions.

### 7.1 Acquiring Initial Timing Advance (TA)

A UE in NR typically acquires DL slot and symbol timing (DL timing in short) based on an SSB and initial UL timing via a random access procedure, in which the UE transmits a PRACH preamble in a PRACH resource associated with the SSB using the DL timing as a reference and a same transmission filter or beam as the one used in receiving the SSB. A timing correction in the form of a TA is then measured and sent from the base station to the UE in a RAR. The TA is carried by a timing advance command (TAC) in the RAR.

### 7.2 Timing Advance Groups (TAGs)

A UE may be configured with multiple serving cells, some of the cells may not be co-located and different TAs may be needed for UL transmissions to those cells. To inform the UE about whether two cells have a same or different TAs, timing advance group (TAG) was introduced in NR. For cells that are co-located and can share a same TA value, they belong to a same TAG and can be configured with a same TAG identifier or index (ID). For cells that are not co-located and need different TAs, they can be configured in different cell groups.

Each serving cell can have a TAG identifier associated with it. Two serving cells configured with a same TAG identifier will be assumed by the UE to belong to a same TAG.

According to TS38.213, upon reception of a timing advance command for a TAG, the UE adjusts uplink timing for PUSCH/Sounding Reference Signal (SRS)/PUCCH transmission on all the serving cells in the TAG based on the received timing advance command where the uplink timing for PUSCH/SRS/PUCCH transmissions is the same for all the serving cells in the TAG.

8 Multi-DCI based Multi-TRP Scheduling

In NR Release 16, multi-DCI based DL and UL scheduling was introduced, in which a UE may receive two DCI formats, a first and a second DCI formats, carried by two PDCCHs, a first and a second PDCCHs, in two CORESETs, a first and a second CORESETs, respectively. The first and second CORESETs are associated with a first and a second CORESET pool indices, respectively. The first and second DCI formats schedule, respectively, a first and a second PDSCHs transmitted from a first and a second transmission and reception points (TRPs), respectively, or schedule a first and a second PUSCHs to the first and second TRPs, respectively.

An example is shown in FIG. 4, where PDCCH1 in CORESET1 with CORESET pool index=0 scheduling PDSCH1 from TRP1 while PDCCH2 in CORESET2 with CORESET pool index=1 scheduling PDSCH2 from TRP2. Similarly, a PDCCH in CORESET1 can schedule a PUSCH towards TRP1 and a PDCCH in CORESET2 can schedule a PUSCH towards TRP2.

For multi-DCI multi-TRP operation, a UE needs to be configured with two CORESET pool indices, each associated with a TRP. Each CORESET pool is a collection of CORESETs configured with a same CORESET pool index.

In case that one of the TRPs is associated to a different PCI (Physical Cell Identifier) than the PCI of the serving cell, the different PCI is also referred to as additional PCI and is provided to the UE by a higher layer parameter “additionalPCI-r17” in a SSB-MTC-AdditionalPCI-r17 IE shown in FIG. 5A according 3GPP TS 38.331 v17.2.0. SSB-MTC-AdditionalPCI-r17 IE provides also information about the SSBs associated to the additional PCI.

Multiple SSB-MTC-AdditionalPCI-r17 IEs may be configured for a UE in a serving cell, each associated to an additional PCI. Each of the multiple SSB-MTC-AdditionalPCI-r17 IEs is assigned an index, “AdditionalPCIIndex-r17”, which has a range from 1 to a maximum number of additional PCIs that can be configured. The multiple SSB-MTC-AdditionalPCI-r17 IEs are configured as “additionalPCI-ToAddModList-r17” in ServingCellConfig 1E shown in FIG. 5B according 3GPP TS38.331 v17.2.0.

The additional PCI information is included in each TCI state associated to the TRP as shown in FIG. 5C according 3GPP TS38.331 v17.2.0.

### 9 Two TAs

In multi-DCI based UL transmissions, the UL timing to different TRPs could be different in practice due to, for example, propagation delay difference and/or timing difference. In NR Rel-18, it has been agreed that different TAs may be supported for UL transmissions to different TRPs. For that purpose, two TAGs will be introduced for a serving cell configured with multi-DCI based scheduling.

It is further agreed that a PDCCH order may be sent from one TRP to trigger a CFRA based PRACH transmission towards a different TRP.

### SUMMARY

Systems and methods are disclosed for determining a transmit power and spatial transmit (Tx) filter for Physical Random Access Channel (PRACH) for a multi-Transmission and Reception Point (TRP) transmission. In one embodiment, a method performed by a User Equipment (UE) comprises receiving from a network node a configuration of a first time advance group (TAG) identity (ID) and a second TAG ID, and a first control resource set (CORESET) with a first CORESET pool index value and a second CORESET with a second CORESET pool index value in a serving cell. The method further comprises receiving from the network node a request in the serving cell to transmit a Physical Random Access Channel (PRACH) preamble, wherein the request comprises a PRACH preamble index associated to the PRACH preamble, information about a downlink reference signal (RS), and information about a Physical Cell Identity (PCI) associated with the downlink RS. The method further comprises determining, based on the information about the downlink RS and the information about the PCI comprised in the request, a transmit power for transmission of the PRACH preamble, and transmitting the PRACH preamble according to the determined transmit power. In this manner, the requested PRACH preamble is transmitted with the correct transmit power when more than one Timing Advance Group (TAG) or Timing Advance (TA) are configured for the serving cell.

In one embodiment, the request is carried in Physical Downlink Control Channel (PDCCH).

In one embodiment, the request is a PDCCH order carried in a Downlink Control Information (DCI) format.

In one embodiment, the first TAG ID is different than the second TAG ID, and the first CORESET pool index value is different than the second CORESET pool index value.

In one embodiment, the downlink RS is a Synchronization Reference Signal (SS) and Physical Broadcast Channel (PBCH) block (SSB).

In one embodiment, the PCI is a PCI of the serving cell or a PCI different than the PCI of the serving cell.

In one embodiment, the information about the PCI associated with the downlink RS indicates the PCI, and the downlink RS is associated to the PCI indicated by the information about the PCI comprised in the request.

In one embodiment, the method further comprising receiving, prior to receiving the request, a configuration of the downlink RS and a transmit power of the downlink RS.

In one embodiment, the information about the downlink RS comprises an index of the downlink RS.

In one embodiment, the information about the PCI comprises an indication indicating whether the PCI is an PCI of the serving cell or an PCI different than the PCI of the serving cell.

In one embodiment, the request is received in a DCI in one of the first and the second CORESETs.

In one embodiment, the request is a PDCCH order carried in a DCI format, the downlink RS is a SSB, the information about the downlink RS is an SSB index of the SSB, the information about the PCI is the PCI, and determining the transmit power for transmission of the PRACH preamble comprises determining the spatial Tx filter and the transmit power for transmission of the PRACH preamble based on the SSB index and the PCI comprised in the PDCCH order.

In one embodiment, the method further comprising determining a spatial filter for transmission of the PRACH preamble based on the downlink RS and the PCI. In one embodiment, the spatial filter is a spatial filter used in receiving the downlink RS,

In one embodiment, determining the transmit power for transmission of the PRACH preamble comprises calculating a pathloss as a difference between a transmit power of the downlink RS and a Reference Signal Received Power (RSRP) measured based on the downlink RS, and determining the transmit power for transmission of the PRACH preamble based on the calculated pathloss.

In one embodiment, the request is received on the serving cell of the UE.

In one embodiment, the method further comprises receiving configuration information that configures the UE with one or more of: a first set of downlink RSs with a first transmit power associated to a first PCI, where the first PCI is a PCI of the serving cell; a first PRACH configuration and a first set of PRACH preambles associated to the first PCI; a list of Transmission Configuration Indicator (TCI) states; a second set of downlink RSs with a second transmit power associated to a second PCI; and a second PRACH configuration and a second set of PRACH preambles associated to the second PCI. In one embodiment, the first PCI and the second PCI are different. In one embodiment, the PCI indicated in the request is one of the first and the second PCIs. In one embodiment, the PRACH preamble indicated in the request is one of the first set of PRACH preambles if the first PCI is indicated in the request, and one of the second set of PRACH preambles if the second PCI is indicated in the request. In one embodiment, the downlink RS indicated in the request is one of the first set of downlink RSs if the first PCI is indicated in the request and one of the second set of downlink RSs if the second PCI is indicated in the request. In one embodiment, the UE is activated with a first TCI state from the list of TCI states for the first CORESET and a second TCI state from the list of TCI states for the second CORESET. In one embodiment, the first set of SSBs is configured with a first SSB transmit power and the second set of SSBs is configured with a second SSB transmit power, wherein values of the first and second SSB transmit powers are either the same or different.

Corresponding embodiments of a UE are also disclosed. In one embodiment, a UE is adapted to receive from a network node a configuration of a first TAG ID and a second TAG ID, and a first CORESET with a first CORESET pool index value and a second CORESET with a second CORESET pool index value in a serving cell. The UE is further adapted to receive from the network node a request in the serving cell to transmit a PRACH preamble, wherein the request comprises a PRACH preamble index associated to the PRACH preamble, information about a downlink reference RS, and information about a PCI associated with the downlink RS. The UE is further adapted to determine, based on the information about the downlink RS and the information about the PCI comprised in the request, a transmit power for transmission of the PRACH preamble, and transmit the PRACH preamble according to the determined transmit power.

Embodiments of a method performed by a network node are also disclosed. In one embodiment, a method performed by a network node comprises transmitting, to a UE, a configuration of a first TAG ID and a second TAG ID, and a first CORESET with a first CORESET pool index value and a second CORESET with a second CORESET pool index value in a serving cell. The method further comprises transmitting, to the UE, a request in the serving cell to transmit a PRACH preamble, wherein the request comprises a PRACH preamble index associated to the PRACH preamble, information about a downlink reference RS, and information about a PCI associated with the downlink RS.

Corresponding embodiments of a network node are also disclosed. In one embodiment, a network node is adapted to transmit, to a UE, a configuration of a first TAG ID and a second TAG ID, and a first CORESET with a first CORESET pool index value and a second CORESET with a second CORESET pool index value in a serving cell. The network node is further adapted to transmit, to the UE, a request in the serving cell to transmit a PRACH preamble, wherein the request comprises a PRACH preamble index associated to the PRACH preamble, information about a downlink reference RS, and information about a PCI associated with the downlink RS.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1A illustrates the New Radio (NR) time domain structure with 15 kilohertz (kHz) subcarrier spacing;

FIG. 1B illustrates the NR physical time-frequency resource grid;

FIG. 2 illustrates the NR ServingCellConfigCommon Information Element (IE);

FIG. 3A illustrates an example of Synchronization Signal Block (SSB) to Physical Random Access Channel (PRACH) preamble mapping with N=½ and R=32;

FIG. 3B illustrates an example of SSB to PRACH preamble mapping with N=4 and R=4;

FIG. 4 illustrates an example of multi-Downlink Control Information (DCI) based scheduling from two Transmission and Reception Points (TRPs);

FIG. 5A illustrates the SSB-MTC IE;

FIG. 5B illustrates the ServingCellConfig 1E;

FIG. 5C illustrates the TCI-State IE;

FIG. 6 illustrates an example of PRACH transmission to one TRP initiated by a

Physical Downlink Control Channel (PDCCH) order received from a different TRP, in accordance with embodiments of the present disclosure;

FIG. 7 is a flow chart that illustrates a method performed by a User Equipment (UE) in accordance with one embodiment of the present disclosure;

FIG. 8 illustrates the operation of a UE, a first TRP (TRP1), and a second TRP (TRP2) in accordance with one embodiment of the present disclosure;

FIG. 9 illustrates an example of an alternative embodiment in which a PDCCH order received from a first TRP initiates PRACH transmissions to both the first TRP and a second TRP;

FIG. 10 is a flow chart that illustrates the operation of a UE for the example in

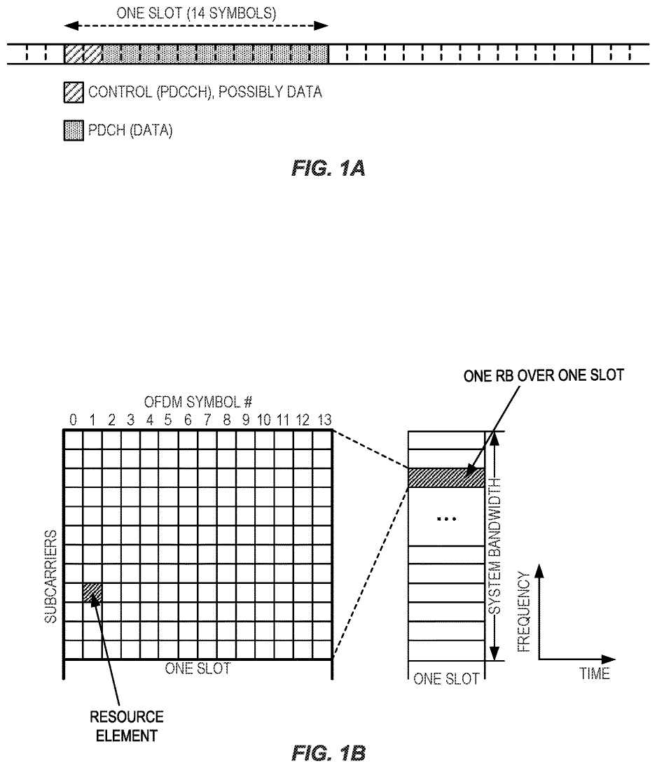

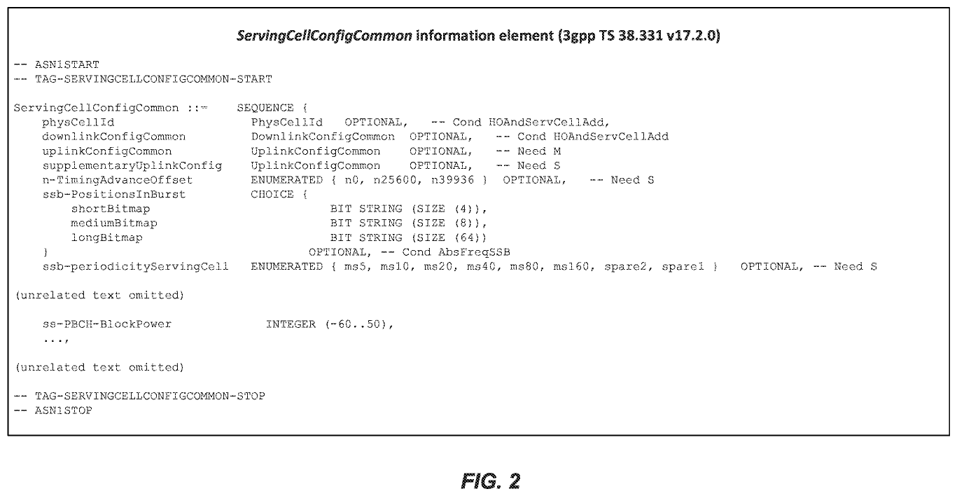

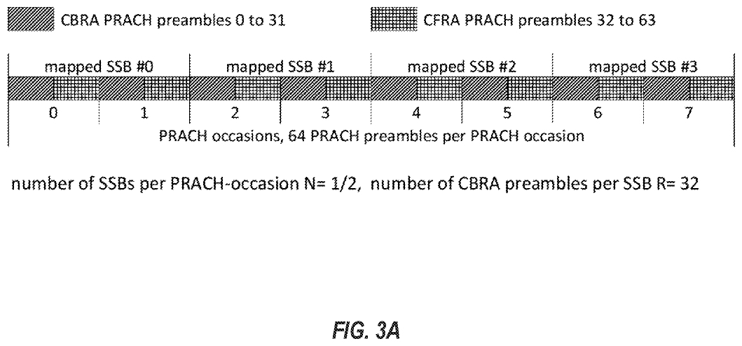

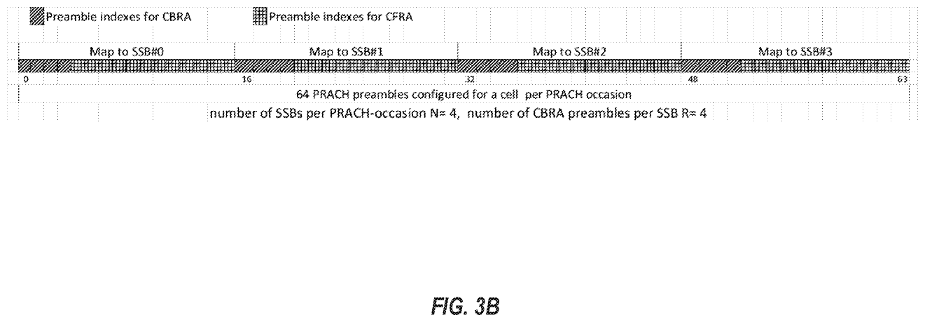

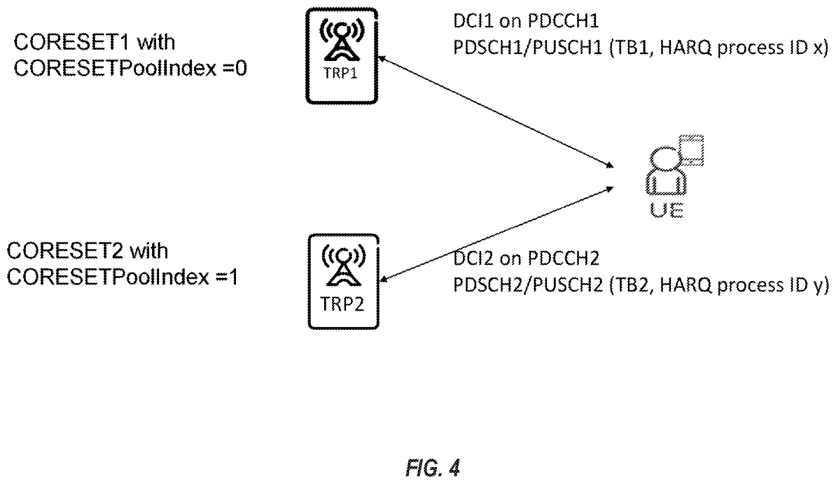

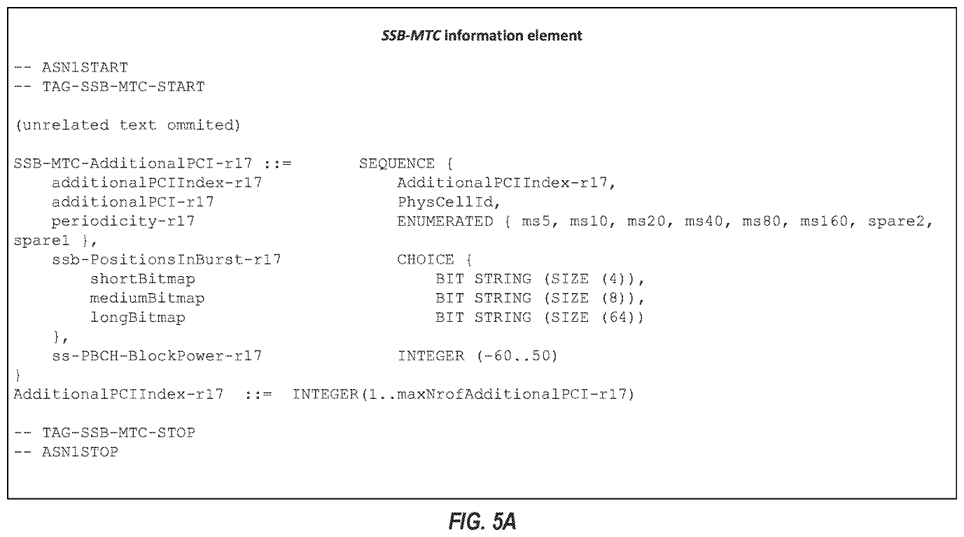

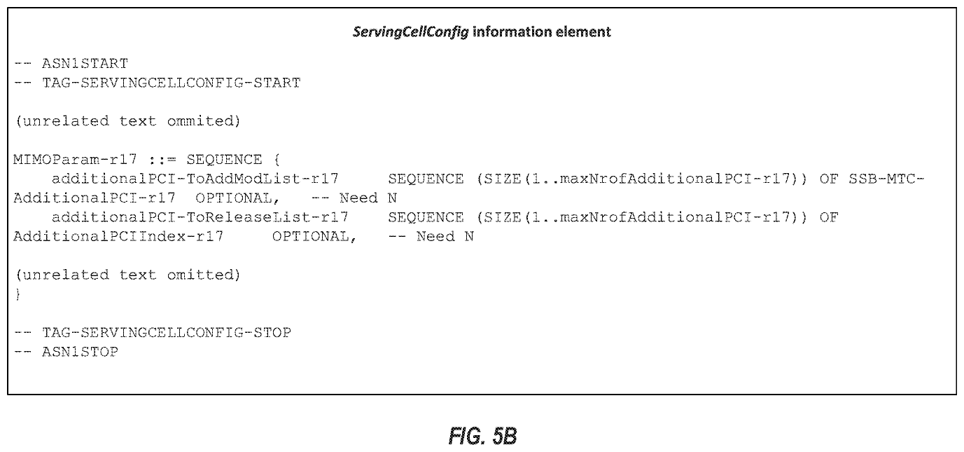

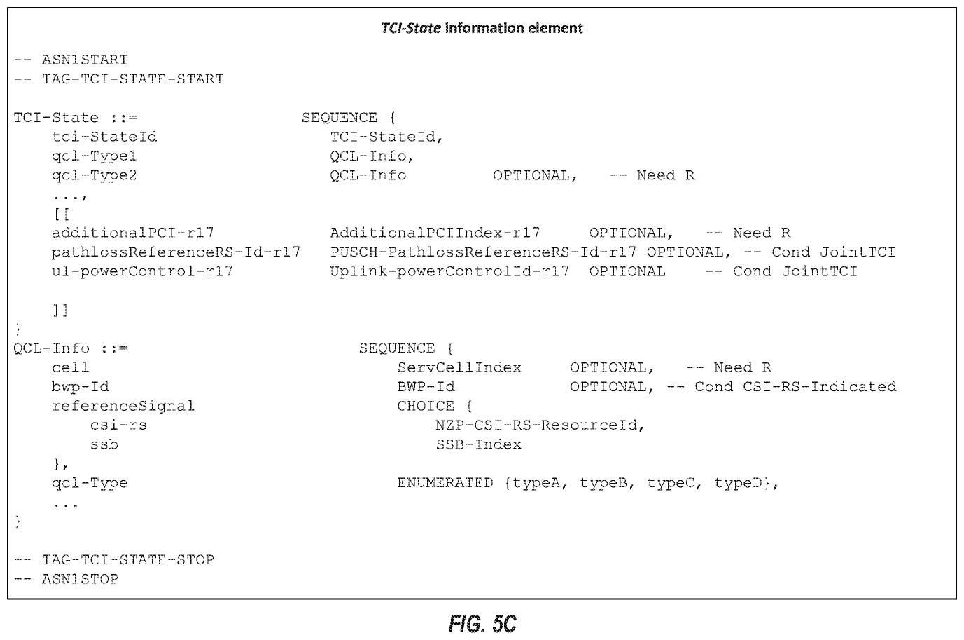

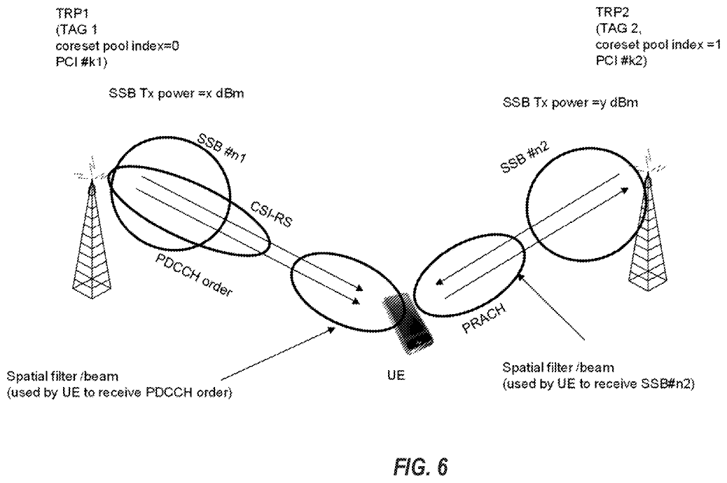

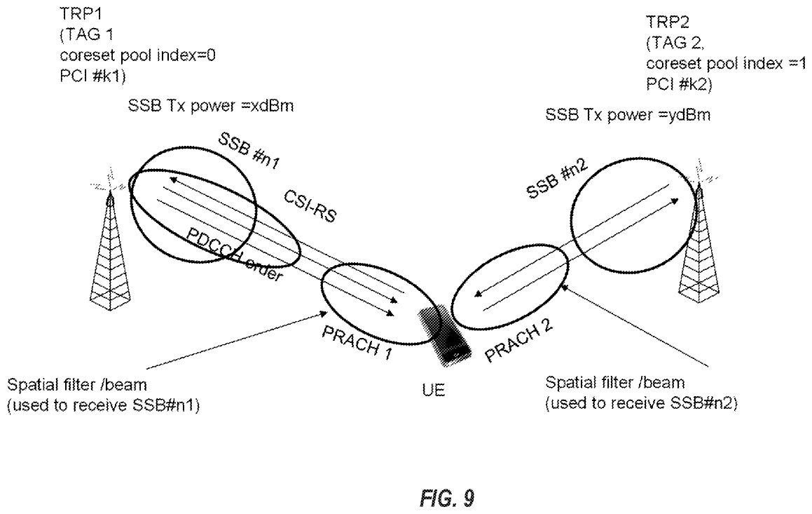

FIG. 9, in accordance with one embodiment of the present disclosure;

FIG. 11 shows an example of a communication system in accordance with some embodiments;

FIG. 12 shows a UE in accordance with some embodiments;

FIG. 13 shows a network node in accordance with some embodiments;

FIG. 14 is a block diagram of a host, which may be an embodiment of the host of FIG. 11, in accordance with various aspects described herein;

FIG. 15 is a block diagram illustrating a virtualization environment in which functions implemented by some embodiments may be virtualized; and

FIG. 16 shows a communication diagram of a host communicating via a network node with a UE over a partially wireless connection in accordance with some embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). In the existing New Radio (NR) specification, what spatial filter should be used for a Physical Random Access Channel (PRACH) transmission is not explicitly specified. The common understanding is that for initial Contention-Based Random Access (CBRA) based PRACH transmission in a PRACH resource associated to a Synchronization Signal Block (SSB), a User Equipment (UE) would use a spatial domain filter with which the SSB was received.

In addition, for determining the PRACH transmit power, a pathloss is calculated as

$${PL}_{b , f , c} = referenceSignalPower - higher layer filtered RSRP in dBm$$

If the PRACH transmission is Content-Free Random Access (CFRA) based and is initiated by a Physical Downlink Control Channel (PDCCH) order, referenceSignalPower is determined based on a downlink (DL) reference signal (RS) for which the Demodulation Reference Signal (DMRS) of the PDCCH order is Quasi Co-Located (QCL) according to 3^{rd} Generation Partnership Project (3GPP) Technical Specification (TS) 38.213. According the specification text copied below, if a QCL type D RS associated to the PDCCH order is a SSB, the SSB transmit power should be used as the reference signal power; otherwise, if the QCL type D RS is a periodic Channel State Information Reference Signal (CSI-RS), the CSI-RS transmit power should be used as referenceSignalPower. Presumably, the “higher layer filtered RSRP” is the Reference Signal Received Power (RSRP) measured on the QCL type-D RS. However, this is not explicitly specified in the 3GPP specification.
“If a PRACH transmission from a UE is in response to a detection of a PDCCH order by the UE that triggers a contention-free random access procedure and depending on the DL RS that the DM-RS of the PDCCH order is quasi-collocated with as described in clause 10.1, referenceSignalPower is provided by ss-PBCH-BlockPower or, if the UE is configured resources for a periodic CSI-RS reception or the PRACH transmission is associated with a link recovery procedure where a corresponding index is associated with a periodic CSI-RS configuration as described in clause 6, referenceSignalPower is obtained by ss-PBCH-BlockPower and powerControlOffsetSS where powerControlOffsetSS provides an offset of CSI-RS transmission power relative to SS/PBCH block transmission power [6, TS 38.214]. If powerControlOffsetSS is not provided to the UE, the UE assumes an offset of 0 dB. If the active TCI state for the PDCCH that provides the PDCCH order includes two RS, the UE expects that one RS is configured with qcl-Type set to ‘typeD’ and the UE uses the one RS when applying a value provided by powerControlOffsetSS.”

In case of a CFRA based PRACH transmission intended to a second Transmission and Reception Point (TRP) is initiated by a PDCCH order received from a first TRP, using the QCL typed RS associated to the PDCCH order to derive a spatial filter and/or transmit power for the PRACH transmission is a problem because the PRACH would be sent towards a wrong TRP and/or with a wrong transmit power.

Certain aspects of the disclosure and their embodiments may provide solutions to these or other challenges. In one embodiment, a method is proposed for determining a spatial filter and/or a transmit power for a PDCCH order initiated PRACH transmission in a serving cell configured with two timing advances (TAs). In one embodiment, this method is performed by a UE. In one embodiment, the method comprises one or more of the following:
Receiving, by a UE, a PDCCH order from a first TRP to transmit a PRACH to a second TRP, where the PDCCH order contains
   a PRACH preamble index
   a PRACH preamble mask
   a SSB index
   for a Physical Cell Identity (PCI) associated to the SSB index
Determining a spatial transmit (Tx) filter and a transmit power for the PRACH transmission to the second TRP according to the SSB indicated by the SSB index and the PCI in the PDCCH order, e.g.,
   Determining the spatial Tx filter according the SSB
   Calculating a pathloss as a difference between a configured SSB transmit power for the SSB and a measured RSRP based on the SSB
   Determine a transmit power based on the pathloss and other power control parameters
Transmit the PRACH preamble according to the determined spatial Tx filter and a transmit power calculated based on the pathloss

In one embodiment, in case of a PRACH transmission to a second TRP is initiated by a PDCCH order received from a first TRP, the SSB index and the PCI information indicated in the PDCCH order are used together to derive a spatial Tx filter and a transmit power for the PRACH transmission.

Certain embodiments may provide one or more of the following technical advantage(s). Embodiments of the present disclosure ensure a PRACH transmission initiated by a PDCCH order is transmitted to the intended TRP with a correct transmit power when more than one Timing Advance Group (TAG) or TA are configured for a serving cell.

Note that a TRP may be, for example, a network node, a base station, an antenna apparatus, an antenna panel, a spatial relation, a Transmission Configuration Indicator (TCI) state, a serving cell, a cell, a Component Carrier (CC), a carrier, and so on. The term “TRP”, “TAG”, “timing advance timer”, and “CORESET pool index” are associated to each other and, in the following, they may sometimes be used interchangeably.

Note on PCI: Serving cell is always associated with one PCI. This PCI is, in one example embodiment, configured by “physCellId” in Information Element (IE) ServingCellConfigCommon described in 3GPP TS 38.331 v17.2.0. Optionally, UE may be configured with additional PCIs using, e.g., the additionalPCI-ToAddModList-r17 in ServingCellConfig 1E, and an additional PCI is the additionalPCI-r17 in a corresponding SSB-MTC-AdditionalPCI-r17. Multi-TRP operation is possible with or without additional PCIs.

Note on TAG: UE may be configured with two timing advance timers. These timers may be associated to one TAG in case there is one TAG configured for a serving cell. Optionally, one TAG may be associated to one timing advance timer, but a serving cell is configured with two TAGs, either using existing IE for the TAG or with a new subTAG.

FIG. 6 shows an example of PRACH transmission to one TRP initiated by a PDCCH order received from a different TRP, where a PDCCH order received from TRP1 initiates a PRACH transmission to TRP2. SSB #n1 is transmitted from TRP1 with x dBm of transmit power, and SSB #n2 is transmitted from TRP2 with y dBm of transmit power. TRP1 is associated to PCI #k1 and Control Resource Set (CORESET) pool index 0, and TRP2 is associated with PCI #k2 and CORESET pool index 1. In addition, TRP1 is associated with TAG1, and TRP2 is associated to TAG2. Embodiments of a method are disclosed herein on how to transmit the PRACH to TRP2 by the UE.

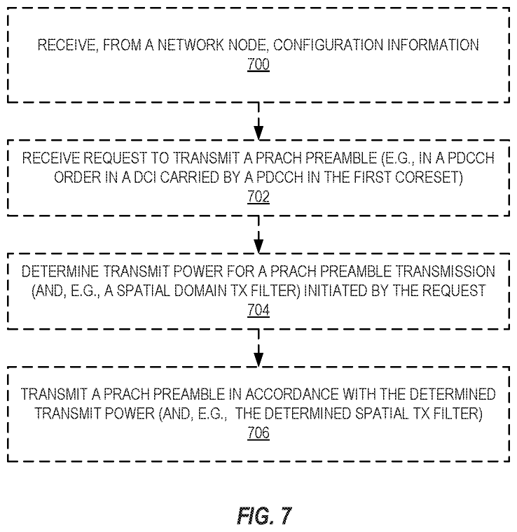

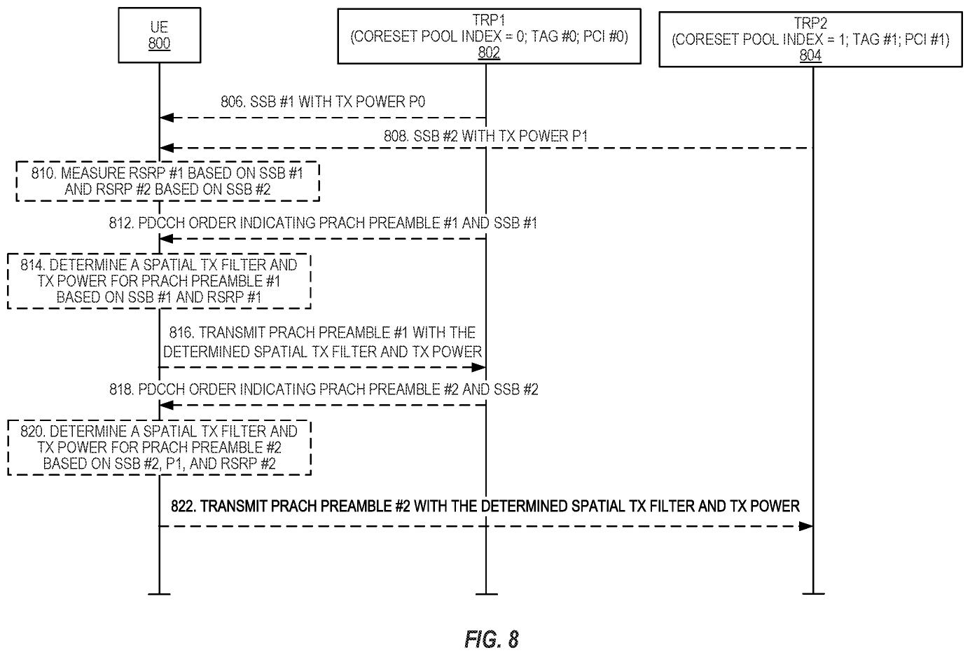

FIG. 7 is a flow chart that illustrates a method performed by a UE in accordance with one embodiment of the present disclosure. Optional steps are represented by dashes lines/boxes. Further, while the steps are illustrated as being in a particular order, the steps can be performed in any order. As illustrated in FIG. 7, the method comprises one or more of the following steps:

Step 700: The UE is configured in a serving cell with one or more of:
a first CORESET with a first coreset pool index and a second CORESET with a second coreset pool index, wherein the first and second CORESET pool indices are different
a first TA and a second TA or a first TAG Identifier (ID) and a second TAG ID
   or, optionally one TAG ID associated with two time alignment timers
a first set of SSBs with a first SSB transmit power associated to a first PCI, where the first PCI is a PCI of the serving cell
a first PRACH configuration and a first set of PRACH preambles associated to the first PCI
a list of TCI states
a second set of SSBs with a second SSB transmit power associated to a second PCI
a second PRACH configuration and a second set of PRACH preambles associated to the second PCI.

The UE is activated with a first TCI state from the list of TCI states for the first CORESET and a second TCI state from the list of TCI states for the second CORESET, where
The first PCI is the PCI of the serving cell and is configured by “physCellId” in IE ServingCellConfigCommon described in 3GPP TS 38.331 v17.2.0.
The second PCI is an additional PCI configured by “additionalPCI-r17” in an “SSB-MTC-AdditionalPCI-r17” configured using the additionalPCI-ToAddModList-r17 in IE ServingCellConfig described in 3GPP TS 38.331 v17.2.0.

In Step 700, the first and second TAG IDs are different and are associated to a first and second time alignment timers, respectively. Alternatively, the first and the second TAG IDs may be the same.

In Step 700, the first and second CORESET pool indices are associated to the first and second TAG IDs, respectively, or the first and second timers in case of that the first and the second TAG IDs are the same, i.e., one TAG IDs with two timers.

In Step 700, the first set of SSBs are configured with a first SSB transmit power and the second set of SSBs are configured with a second SSB transmit power. The values of the first and second SSB transmit powers can be the same or different.

In Step 700, the first PCI is different from the second PCI when additionalPCI-ToAddModList-r17 is configured in IE ServingCellConfig of the serving cell in 3GPP TS 38.331 v17.2.0.

In Step 700, the first and the second PCI are associated to a first and a second PCI indices, respectively, where PCI index is as described in Step 702.

In Step 700, one of the following two associations is possible:
the first CORESET is associated to the first PCI, and the second CORESET is associated to the second PCI
the first CORESET is associated to the second PCI, and the second CORESET is associated to the first PCI.

Step 702: The UE receives a PDCCH order in a Downlink Control Information (DCI) format 1_0 carried by a PDCCH in the first CORESET, where the PDCCH order contains
a PRACH preamble index
a PRACH preamble mask,
a first SSB index
a PCI index associated with the first SSB index where the PCI index is an integer and has a value from 0 to maxNrofAdditionalPCI-r17, where maxNrofAdditionalPCI-r17 is pre-defined or configured, and
If the PCI index value equals to zero or the PCI index field is not present, it indicates the first PCI, i.e., the PCI of the serving cell
otherwise, if the PCI index value is non-zero, the PCI index corresponds to additionalPCIIndex-r17 of an SSB-MTC-AdditionalPCI-r17 configured using the additionalPCI-ToAddModList-r17 in ServingCellConfig. The corresponding PCI is the second PCI and is given by PhysCellId in the SSB-MTC-AdditionalPCI-r17.

If additionalPCI-ToAddModList-r17 is not configured in the serving cell, the PCI index is always set to 0 or the field is not present. If additionalPCI-ToAddModList-r17 is present in serving cell configuration, the PCI index may be set to any value in the range of 0 to maxNrofAdditionalPCI-r17.

If the PRACH preamble index is non-zero, whether the PRACH preamble index is from the first or the second sets of PRACH preambles is determined by the PCI index contained in the PDCCH order. The PRACH preamble is from the first set of PRACH preambles if the first PCI is indicated by the PCI index, otherwise, the PRACH preamble is from the second set of PRACH preambles.

If the preamble index is zero and if dedicated CFRA PRACH resource (e.g., by RACH-ConfigDedicated IE) is not configured for the PCI indicated by the PCI index, the PRACH transmission is a CBRA based PRACH transmission. A PRACH preamble is selected from a set of PRACH preambles associated to a PCI indicated by the PCI index in the PDCCH order, where the PCI is one of the first and the second PCI, and the set of PRACH preambles is one of the first and second sets of PRACH preambles.

In Step 702, if the preamble index is zero and SSBs associated with CFRA resources are provided for the PCI indicated by the PCI index in the PDCCH order in a dedicated RACH configuration IE (e.g., RACH-ConfigDedicated IE), where a one to one mapping between a preamble index and a SSB index is provided for a list of SSBs, the UE select a SSB with SSB-RSRP above a configured threshold, rsrp-ThresholdSSB, amongst the first SSB set if the first PCI is indicated by PCI index, and select a PRACH preamble corresponding to the selected SSB; otherwise, UE select a SSB with SSB-RSRP above a configured threshold amongst the second SSB set, and select a PRACH preamble corresponding to the selected SSB.

In Step 702, if the preamble index is zero and CSI-RSs associated with CFRA resources are provided for the PCI indicated by the PCI index in the PDCCH order in a dedicated RACH configuration IE (e.g., RACH-ConfigDedicated IE), where a one to one mapping between a preamble index and a CSI-RS resource is provided for a list of SSBs. A first CSI-RS set is associated with a first PCI index and a second CSI-RS set is associated with a second PCI index. UE select a CSI-RS with CSI-RSRP above a configured threshold, rsrp-ThresholdCSI-RS, amongst the first CSI-RS set if the first PCI is indicated by PCI index, and select a PRACH preamble corresponding to the selected CSI-RS; otherwise, UE select a CSI-RS with CSI-RSRP above a configured threshold amongst the second CSI-RS set, and select a PRACH preamble corresponding to the selected CSI-RS.

In Step 702, the first SSB index is associated to the first set of SSBs if the first PCI is indicated by the PCI index, and is associated to the second set of SSBs if the second PCI is indicated by the PCI index.

Step 704: The UE determines a spatial domain Tx filter and a transmit power for a PRACH transmission triggered by the PDCCH order. This step of determining comprises, in one embodiment:
Determining the spatial domain Tx filter according to a first SSB indicated by the first SSB index and the PCI index contained in the PDCCH order, if the PRACH preamble index is non-zero
Calculating a pathloss based on a configured SSB transmit power for the first SSB and a previously measured RSRP based on the first SSB, if the PRACH preamble index is non-zero.
   If the PCI index contained in the PDCCH order indicates the first PCI, i.e., the serving cell PCI, the first SSB transmit power is used, and the first SSB transmit power is given by ss-PBCH-BlockPower configured in ServingCellConfigCommon IE
   Otherwise, if the PCI index indicates the second PCI that is not the serving cell PCI, then the second SSB transmit power is used, and the second SSB transmit power is given by ss-PBCH-BlockPower-r17 configured in an SSB-MTC-AdditionalPCI-r17 associated to an additionalPCIIndex-r17 with the same value as the PCI index.
If the PRACH preamble index is zero and SSBs associated with CFRA resources are provided for the PCI indicated by the PCI index in the PDCCH order,
   Determining the spatial domain Tx filter according to the selected SSB associated to a PCI indicated by the PCI index, or
   Determining the spatial domain Tx filter according to the selected CSI-RS associated to a PCI indicated by the PCI index
   Calculating a pathloss based on a configured SSB/CSI-RS transmit power for the selected SSB/CSI-RS and a previously measure RSRP based on the selected SSB/CSI-RS
      If the PCI index contained in the PDCCH order indicates the first PCI, i.e., the serving cell PCI, the first SSB transmit power is used.
      Otherwise, if the PCI index contained in the PDCCH order indicates the second PCI, then the second SSB transmit power is used.
Calculating a transmit power based on the determined pathloss, and additional power control parameters

In Step 704, where the determining a spatial Tx filter according a first SSB indicated by the first SSB index and the PCI index comprises using a same spatial domain Rx filter previously used for receiving the first SSB as the spatial domain Tx filter.

In Step 704, where the calculating a pathloss based on a SSB transmit power for a SSB and a previously measured RSRP based on the SSB comprises calculating the pathloss in dB by subtracting the RSRP in dBm from the SSB transmit power in dBm.

Step 706: The UE transmits the PRACH preamble according to the determined spatial domain Tx filter and the calculated transmit power

In Step 706, the PRACH preamble is transmitted in a PRACH occasion indicated by the preamble mask, the first SSB index and the PCI index.

Note about steps 704 and 706 above. The SSB index is unambiguous if the serving cell is not configured with additionalPCI-ToAddModList-r17. If additionalPCI-ToAddModList-r17 is configured, UE needs to use the PCI index together with SSB index to determine the correct SSB beam to be used in these steps.

FIG. 8 illustrates the operation of a UE 800, a first TRP (TRP1) 802, and a second TRP (TRP2) 804 in accordance with one embodiment of the present disclosure. Optional steps are represented by dashes lines/boxes. Further, while the steps are illustrated as being in a particular order, the steps can be performed in any order. The first TRP 802 is associated to a first CORESET pool having, in this example, a CORSET pool index=0 and further associated to a first TAG (TAG #0) and a first PCI (PCI #0). The second TRP 804 is associated to a second CORESET pool having, in this example, a CORSET pool index=1 and further associated to a second TAG (TAG #1) and a second PCI (PCI #1). As illustrated, the process includes any one or more of steps 806-822.

The first TRP 802 transmits a first SSB (SSB #1) with a first TX power (P0) (step 806), and the second TRP 804 transmits a second SSB (SSB #2) with a second TX power (P1) (step 808). The UE 800 measures a first RSRP (RSRP #1) based on the first SSB (SSB #1) and a second RSRP (RSRP #2) based on the second SSB (SSB #2) (step 810).

In this example, optionally, the UE 800 receives a PDCCH order indicating a first PRACH preamble (PRACH preamble #1), the first SSB (SSB #1), and the first PCI (step 812). The UE 800 determines a spatial TX filter and TX power for the first PRACH preamble (PRACH preamble #1) based on the first SSB (SSB #1), the first RSRP (RSRP #1), and the first PCI (step 814). The UE 800 transmits the first PRACH preamble (PRACH preamble #1) with (i.e., using) the determined spatial TX filter and TX power from step 814 (step 816).

The UE 800 receives a PDCCH order indicating a second PRACH preamble (PRACH preamble #2), the second SSB (SSB #2), and a second PCI (step 818). The UE 800 determines a spatial TX filter and TX power for the second PRACH preamble (PRACH preamble #2) based on the second SSB (SSB #2), the second RSRP (RSRP #2), and the second PCI (step 820). The UE 800 transmits the second PRACH preamble (PRACH preamble #2) with (i.e., using) the determined spatial TX filter and TX power from step 820 (step 822).

Alternative embodiments related to the case when a PDCCH order received from one of the TRPs initiates PRACH transmissions to both TRPs are next described. An example for this case is shown in FIG. 9.

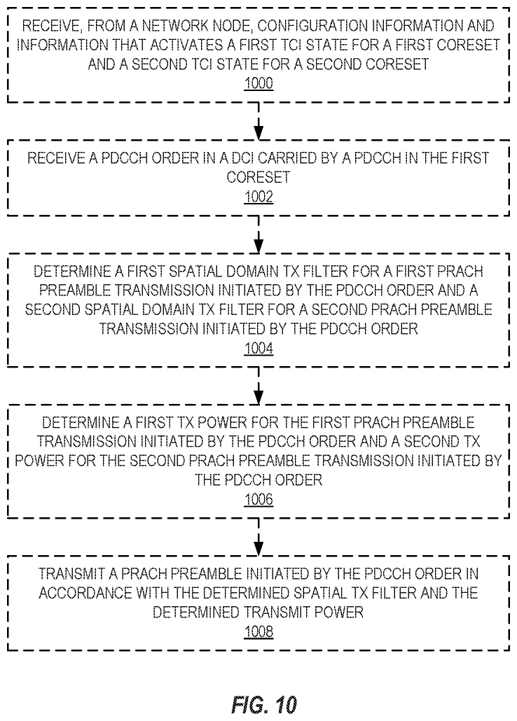

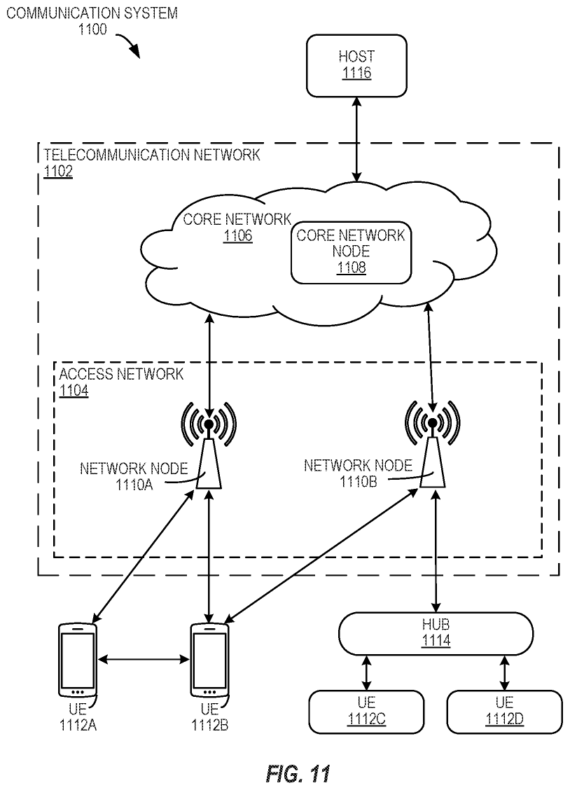

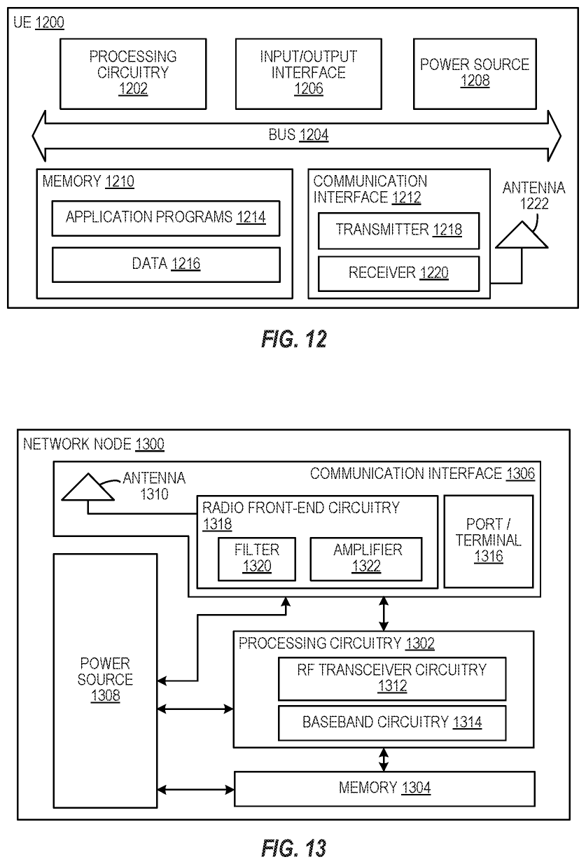

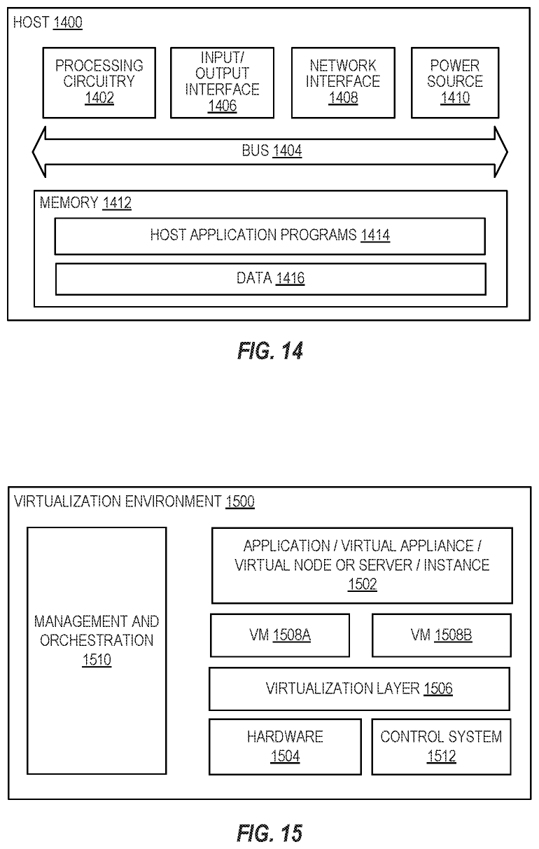

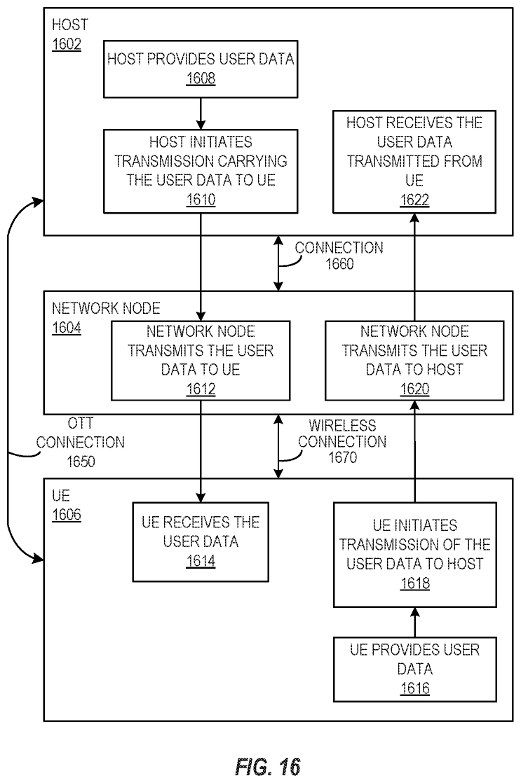

FIG. 10 is a flow chart that illustrates the operation of a UE for the example in FIG. 9, in accordance with one embodiment of the present disclosure. Optional steps are represented by dashes lines/boxes. Further, while the steps are illustrated as being in a particular order, the steps can be performed in any order. As illustrated in FIG. 10, the UE performs one or more of the following steps:
Step 1000: The UE is configured by a serving cell with:
   a first CORESET with a first coreset pool index and a second CORESET with a first coreset pool index, wherein the first and second coreset pool indices are different
   a first TAG and a second TAG associated with the serving cell, or alternatively one TAG but first timing advance timer and second timing advance timer
   a first set of SSBs each with a SSB index associated to a first PCI
   a list of PRACH preambles
   a list of TCI states for the first and second CORESETs
   a second set of SSBs associated to a second PCI and the UE is activated with a first TCI state from the list of TCI states for the first CORESET and a second TCI state from the list of TCI states for the second CORESET.
Step 1002: The UE receives a PDCCH order in a downlink DCI format carried by a PDCCH in the first CORESET, where the PDCCH order contains
   a first PRACH preamble index, and optionally a second PRACH preamble index
   a first SSB index and a second SSB index
   a first preamble mask, and optionally a second preamble mask
   a first PCI index associated with the first SSB index, and a second PCI index associated with the second SSB index

Note that in some cases, the first PCI index may not be explicitly indicated in the PDCCH order. In this case, the UE assumes a predefined value for the first PCI index. For example, in one embodiment, the UE may assume the first PCI index has value 0 in which case the first PCI corresponds to the serving cell TRP.

Note also that if UE is not configured with additionalPCI-ToAddModList then first PCI and second PCI are the same and PDCCH order either provides index 0 for PCI or PCI index is not included in the PDCCH order.
Step 1004: The UE determines a first spatial domain Tx filter and a second spatial domain Tx filter respectively for a first PRACH transmission and a second PRACH transmission triggered by the PDCCH order. In one embodiment, this determining comprises:
   Determining the first spatial domain Tx filter according a first SSB indicated by the first SSB index
   Determining the second spatial domain Tx filter according a second SSB indicated by the second SSB index
Step 1006: The UE determines a first transmit power and a second transmit power respectively for the first PRACH transmission and the second PRACH transmission triggered by the PDCCH order. In one embodiment, this determining comprises:
   Calculating a first pathloss based on a first configured SSB transmit power for the first SSB and a previously measured first RSRP based on the first SSB
   Calculating a second pathloss based on a second configured SSB transmit power for the second SSB and a previously measured second RSRP based on the second SSB
   Calculating a first transmit power based on the first determined pathloss, and a first set of power control parameters
   Calculating a second transmit power based on the second determined pathloss, and a second set of power control parameters
Step 1008: The UE transmits the first PRACH preamble according to the determined first spatial domain Tx filter and the first transmit power calculated and transmit the second PRACH preamble according to the determined second spatial domain Tx filter and the second transmit power calculated

In Step 1004, where the determining a first spatial Tx filter according a first SSB indicated by the first SSB index comprises using a same first spatial domain Rx filter previously used for receiving the first SSB as the first spatial domain Tx filter.

In Step 1004, where the determining a second spatial Tx filter according a second SSB indicated by the second SSB index comprises using a same second spatial domain Rx filter previously used for receiving the second SSB as the second spatial domain Tx filter.

In Step 1006, where calculating a first pathloss based on a configured first SSB transmit power for the first SSB and a previously measured first RSRP based on the first SSB comprises subtracting the first RSRP from the first SSB transmit power

In Step 1006, where calculating a second pathloss based on a configured second SSB transmit power for the second SSB and a previously measured second RSRP based on the second SSB comprises subtracting the second RSRP from the second SSB transmit power

In Step 1008, the first PRACH preamble is transmitted in a first PRACH occasion indicated by the first preamble mask and the first SSB index.

In Step 1008, the second PRACH preamble is transmitted in a second PRACH occasion indicated by the second preamble mask and the second SSB index.

Note about SSB index regarding steps above. The SSB index is unambiguous if serving cell is not configured with additionalPCI-ToAddModList. If additionalPCI-ToAddModList is configured, UE needs to use the PCI index together with SSB index to determine the correct SSB beam to be used in these steps.

FIG. 11 shows an example of a communication system 1100 in accordance with some embodiments.

In the example, the communication system 1100 includes a telecommunication network 1102 that includes an access network 1104, such as a Radio Access Network (RAN), and a core network 1106, which includes one or more core network nodes 1108. The access network 1104 includes one or more access network nodes, such as network nodes 1110A and 1110B (one or more of which may be generally referred to as network nodes 1110), or any other similar Third Generation Partnership Project (3GPP) access node or non-3GPP Access Point (AP). The network nodes 1110 facilitate direct or indirect connection of User Equipment (UE), such as by connecting UEs 1112A, 1112B, 1112C, and 1112D (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system 1100 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1102 is a cellular network that implements 3GPP standardized features. Accordingly, the telecommunication network 1102 may support network slicing to provide different logical networks to different devices that are connected to the telecommunication network 1102. For example, the telecommunication network 1102 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IOT) services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1114 communicates with the access network 1104 to facilitate indirect communication between one or more UEs (e.g., UE 1112C and/or 1112D) and network nodes (e.g., network node 1110B). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a Virtual Reality (VR) headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110B. The hub 1114 may also allow for a different communication scheme and/or schedule between the hub 1114 and UEs (e.g., UE 1112C and/or 1112D), and between the hub 1114 and the core network 1106. In other examples, the hub 1114 is connected to the core network 1106 and/or one or more UEs via a wired connection. Moreover, the hub 1114 may be configured to connect to a Machine-to-Machine (M2M) service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110B. In other embodiments, the hub 1114 may be a non-dedicated hub—that is, a device which is capable of operating to route communications between the UEs and the network node 1110B, but which is additionally capable of operating as a communication start and/or end point for certain data channels.

FIG. 12 shows a UE 1200 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IOT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1202 may include multiple Central Processing Units (CPUs). In the example, the input/output interface 1206 may be configured to provide an

interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging the power source 1208. Power circuitry may perform any formatting, converting, or other modification to the power from the power source 1208 to make the power suitable for the respective components of the UE 1200 to which power is supplied.

The memory 1210 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1210 may allow the UE 1200 to access instructions, application programs, and the like stored on transitory or non-transitory memory media, to off-load data, or to upload data. An article of manufacture, such as one utilizing a communication system, may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., the antenna 1222) and may share circuit components, software, or firmware, or alternatively be implemented separately.

In the illustrated embodiment, communication functions of the communication interface 1212 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1212, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 13 shows a network node 1300 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes processing circuitry 1302, memory 1304, a communication interface 1306, and a power source 1308. The network node 1300 may be composed of multiple physically separate components (e.g., a Node B component and an RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1300 may be configured to support multiple RATs. In such embodiments, some components may be duplicated (e.g., separate memory 1304 for different RATs) and some components may be reused (e.g., an antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1300.

The processing circuitry 1302 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1300 components, such as the memory 1304, to provide network node 1300 functionality.

In some embodiments, the processing circuitry 1302 includes a System on a Chip (SOC). In some embodiments, the processing circuitry 1302 includes one or more of Radio Frequency (RF) transceiver circuitry 1312 and baseband processing circuitry 1314. In some embodiments, the RF transceiver circuitry 1312 and the baseband processing circuitry 1314 may be on separate chips (or sets of chips), boards, or units, such as radio units and digital units. In alternative embodiments, part or all of the RF transceiver circuitry 1312 and the baseband processing circuitry 1314 may be on the same chip or set of chips, boards, or units.

The memory 1304 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and the memory 1304 are integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. The radio front-end circuitry 1318 comprises filters 1320 and amplifiers 1322. The radio front-end circuitry 1318 may be connected to the antenna 1310 and the processing circuitry 1302. The radio front-end circuitry 1318 may be configured to condition signals communicated between the antenna 1310 and the processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of the filters 1320 and/or the amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface 1306 may comprise different components and/or different combinations of components.

In certain alternative embodiments, the network node 1300 does not include separate radio front-end circuitry 1318; instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes the one or more ports or terminals 1316, the radio front-end circuitry 1318, and the RF transceiver circuitry 1312 as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, the communication interface 1306, and/or the processing circuitry 1302 may be configured to perform any receiving operations and/or certain obtaining operations described herein as being performed by the network node 1300. Any information, data, and/or signals may be received from a UE, another network node, and/or any other network equipment. Similarly, the antenna 1310, the communication interface 1306, and/or the processing circuitry 1302 may be configured to perform any transmitting operations described herein as being performed by the network node 1300. Any information, data, and/or signals may be transmitted to a UE, another network node, and/or any other network equipment.

The power source 1308 provides power to the various components of the network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid or an electricity outlet) via input circuitry or an interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

FIG. 14 is a block diagram of a host 1400, which may be an embodiment of the host 1116 of FIG. 11, in accordance with various aspects described herein. As used herein, the host 1400 may be or comprise various combinations of hardware and/or software including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and memory 1412. Other components may be included in other embodiments. Features of these components may be substantially similar to those described with respect to the devices of previous figures, such as FIGS. 12 and 13, such that the descriptions thereof are generally applicable to the corresponding components of the host 1400.

The memory 1412 may include one or more computer programs including one or more host application programs 1414 and data 1416, which may include user data, e.g. data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for Over-The-Top (OTT) services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or VM Monitors (VMMs)), provide VMs 1508A and 1508B (one or more of which may be generally referred to as VMs 1508), and/or perform any of the functions, features, and/or benefits described in relation with some embodiments described herein. The virtualization layer 1506 may present a virtual operating platform that appears like networking hardware to the VMs 1508.

The VMs 1508 comprise virtual processing, virtual memory, virtual networking, or interface and virtual storage, and may be run by a corresponding virtualization layer 1506. Different embodiments of the instance of a virtual appliance 1502 may be implemented on one or more of the VMs 1508, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1508 may be a software implementation of a physical machine that runs programs as if they were executing on a physical, non-virtualized machine. Each of the VMs 1508, and that part of the hardware 1504 that executes that VM, be it hardware dedicated to that VM and/or hardware shared by that VM with others of the VMs 1508, forms separate virtual network elements. Still in the context of NFV, a virtual network function is responsible for handling specific network functions that run in one or more VMs 1508 on top of the hardware 1504 and corresponds to the application 1502.

The hardware 1504 may be implemented in a standalone network node with generic or specific components. The hardware 1504 may implement some functions via virtualization. Alternatively, the hardware 1504 may be part of a larger cluster of hardware (e.g., such as in a data center or CPE) where many hardware nodes work together and are managed via management and orchestration 1510, which, among others, oversees lifecycle management of the applications 1502. In some embodiments, the hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1512 which may alternatively be used for communication between hardware nodes and radio units.

FIG. 16 shows a communication diagram of a host 1602 communicating via a network node 1604 with a UE 1606 over a partially wireless connection in accordance with some embodiments. Example implementations, in accordance with various embodiments, of the UE (such as the UE 1112A of FIG. 11 and/or the UE 1200 of FIG. 12), the network node (such as the network node 1110A of FIG. 11 and/or the network node 1300 of FIG. 13), and the host (such as the host 1116 of FIG. 11 and/or the host 1400 of FIG. 14) discussed in the preceding paragraphs will now be described with reference to FIG. 16.

Like the host 1400, embodiments of the host 1602 include hardware, such as a communication interface, processing circuitry, and memory. The host 1602 also includes software, which is stored in or is accessible by the host 1602 and executable by the processing circuitry. The software includes a host application that may be operable to provide a service to a remote user, such as the UE 1606 connecting via an OTT connection 1650 extending between the UE 1606 and the host 1602. In providing the service to the remote user, a host application may provide user data which is transmitted using the OTT connection 1650.

The network node 1604 includes hardware enabling it to communicate with the host 1602 and the UE 1606 via a connection 1660. The connection 1660 may be direct or pass through a core network (like the core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by the UE 1606 and executable by the UE's processing circuitry. The software includes a client application, such as a web browser or operator-specific “app” that may be operable to provide a service to a human or non-human user via the UE 1606 with the support of the host 1602. In the host 1602, an executing host application may communicate with the executing client application via the OTT connection 1650 terminating at the UE 1606 and the host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via the connection 1660 between the host 1602 and the network node 1604 and via a wireless connection 1670 between the network node 1604 and the UE 1606 to provide the connection between the host 1602 and the UE 1606. The connection 1660 and the wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604 in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR, or AR which it can broadcast, multicast, or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1650 between the host 1602 and the UE 1606 in response to variations in the measurement results. The measurement procedure and/or the network functionality for reconfiguring the OTT connection 1650 may be implemented in software and hardware of the host 1602 and/or the UE 1606. In some embodiments, sensors (not shown) may be deployed in or in association with other devices through which the OTT connection 1650 passes; the sensors may participate in the measurement procedure by supplying values of the monitored quantities exemplified above, or by supplying values of other physical quantities from which software may compute or estimate the monitored quantities. The reconfiguring of the OTT connection 1650 may include message format, retransmission settings, preferred routing, etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency, and the like by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally. Some exemplary embodiments of the present disclosure are as follows:

### Group A Embodiments

Embodiment 1: A method performed by a User Equipment, UE, the method comprising any one or more of the following:
   receiving (702) a PDCCH order from a first TRP to transmit a PRACH preamble to a second TRP;
   determining (704) a spatial Tx filter and transmit power for transmission of the PRACH preamble to the second TRP; and
   transmitting (706) the PRACH preamble according to the determined spatial Tx filter and the determined transmit power.
Embodiment 2: The method of embodiment 1 wherein the PDCCH order comprise a PRACH preamble index associated to the PRACH preamble, a PRACH preamble mask, an SSB index, and a PCI associated with the SSB index.
Embodiment 3: The method of embodiment 2 wherein determining the spatial Tx filter and the transmit power for transmission of the PRACH preamble to the second TRP comprises determining the spatial Tx filter and the transmit power for transmission of the PRACH preamble to the second TRP based on the SSB index and the PCI comprised in the PDCCH order.
Embodiment 4: The method of embodiment 2 wherein determining the spatial Tx filter and the transmit power for transmission of the PRACH preamble to the second TRP comprises: determining the spatial Tx filter for transmission of the PRACH preamble based on the SSB index.
Embodiment 5: The method of embodiment 2 or 4 wherein determining the spatial Tx filter and the transmit power for transmission of the PRACH preamble to the second TRP comprises: calculating a pathloss as a difference between a configured SSB transmit power for an SSB associated to the SSB index and an RSRP measured based on the SSB associated to the SSB index; and determining the transmit power for transmission of the PRACH preamble based on the pathloss (and optionally one or more other power control parameters).
Embodiment 6: The method of any of embodiments 1 to 5 wherein the PDCCH order is received on a serving cell of the UE, where the serving cell is configured with two timing advances or two timing advance groups.
Embodiment 7: The method of any of embodiments 1 to 5 wherein the UE is configured in a serving cell on which the PDCCH order is received with one or more of:
   a first CORESET with a first CORESET pool index and a second CORESET with a second CORESET pool index, wherein the first and second CORESET pool indices are different;
   a first TA and a second TA or a first TAG ID and a second TAG ID or one TAG ID associated with two time alignment timers;
   a first set of SSBs with a first SSB transmit power associated to a first PCI, where the first PCI is a PCI of the serving cell
   a first PRACH configuration and a first set of PRACH preambles associated to the first PCI;
   a list of TCI states;
   a second set of SSBs with a second SSB transmit power associated to a second PCI;
   a second PRACH configuration and a second set of PRACH preambles associated to the second PCI.
Embodiment 8: The method of embodiment 7 wherein the second PCI is a PCI of a cell associated to the second TRP to which the PRACH preamble is transmitted.
Embodiment 9: The method of embodiment 7 or 8 wherein the UE is activated with a first TCI state from the list of TCI states for the first CORESET and a second TCI state from the list of TCI states for the second CORESET.
Embodiment 10: The method of any of embodiments 7 to 9 wherein the first set of SSBs are configured with a first SSB transmit power and the second set of SSBs are configured with a second SSB transmit power, wherein values of the first and second SSB transmit powers are either the same or different.
Embodiment 11: The method of any of embodiments 7 to 10 wherein one of the following two associations is possible:
   the first CORESET is associated to the first PCI, and the second CORESET is associated to the second PCI, or
   the first CORESET is associated to the second PCI, and the second CORESET is associated to the first PCI.
Embodiment 12: A method performed by a User Equipment, UE, the method comprising any one or more of the following:
   receiving (1002) a PDCCH order from a first TRP to transmit a first PRACH preamble to a first TRP and transmit a second PRACH preamble to a second TRP;
   determining (1004) a first spatial Tx filter for transmission of the first PRACH preamble to the first TRP;
   determining (1004) a second spatial Tx filter for transmission of the second PRACH preamble to the first TRP;
   determining (1006) a first Tx power for transmission of the first PRACH preamble to the first TRP;
   determining (1006) a second Tx power for transmission of the second PRACH preamble to the second TRP;
   transmitting (1008) the first PRACH preamble according to the determined first spatial Tx filter and the determined first transmit power; and
   transmitting (1008) the second PRACH preamble according to the determined second spatial Tx filter and the determined second transmit power.
Embodiment 13: The method of embodiment 12 wherein the PDCCH order comprises any one or more of:
   a first PRACH preamble index associated to the first PRACH preamble;
   optionally a second PRACH preamble index associated to the second PRACH preamble;
   a first PRACH preamble mask;
   optionally a second PRACH preamble mask;
   a first SSB index;
   a second SSB index;
   a first PCI index associated with the first SSB index; and
   a second PCI index associated with the second SSB index.
Embodiment 14: The method of embodiment 13 wherein: determining the first spatial Tx filter comprises determining the first spatial Tx filter for transmission of the first PRACH preamble based on the first SSB index; and determining the second spatial Tx filter comprises determining the second spatial Tx filter for transmission of the second PRACH preamble based on the second SSB index.
Embodiment 15: The method of embodiment 13 or 14 wherein determining the first transmit power for transmission of the first PRACH preamble comprises any one or more of: calculating a first pathloss as a difference between a configured SSB transmit power for an SSB associated to the first SSB index and an RSRP measured based on the SSB associated to the first SSB index; and determining the first transmit power for transmission of the first PRACH preamble based on the first pathloss (and optionally one or more other power control parameters).
Embodiment 16: The method of any of embodiment 13 to 15 wherein determining the second transmit power for transmission of the second PRACH preamble comprises any one or more of: calculating a second pathloss as a difference between a configured SSB transmit power for an SSB associated to the second SSB index and an RSRP measured based on the SSB associated to the second SSB index; and determining the second transmit power for transmission of the second PRACH preamble based on the second pathloss (and optionally one or more other power control parameters).
Embodiment 17: The method of any of the previous embodiments, further comprising: providing user data; and forwarding the user data to a host via the transmission to the network node.

### Group B Embodiments

Embodiment 18: A method performed by a first TRP, the method comprising: transmitting (818) a PDCCH order to a UE to transmit a PRACH preamble to a second TRP.
Embodiment 19: The method of embodiment 18 wherein the PDCCH order comprise a PRACH preamble index associated to the PRACH preamble, a PRACH preamble mask, an SSB index, and a PCI associated with the SSB index.
Embodiment 20: The method of embodiment 18 or 19 wherein the PDCCH order further instructs the UE to transmit another PRACH preamble to the first TRP.
Embodiment 21: The method of any of the previous embodiments, further comprising: obtaining user data; and forwarding the user data to a host or a user equipment.

### Group C Embodiments

Embodiment 22: A user equipment comprising: processing circuitry configured to perform any of the steps of any of the Group A embodiments; and power supply circuitry configured to supply power to the processing circuitry.
Embodiment 23: A network node comprising: processing circuitry configured to perform any of the steps of any of the Group B embodiments; and power supply circuitry configured to supply power to the processing circuitry.
Embodiment 24: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Embodiment 25: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.
Embodiment 26: The host of the previous embodiment, wherein the cellular network further includes a network node configured to communicate with the UE to transmit the user data to the UE from the host.
Embodiment 27: The host of the previous 2 embodiments, wherein: the processing circuitry of the host is configured to execute a host application, thereby providing the user data; and the host application is configured to interact with a client application executing on the UE, the client application being associated with the host application.
Embodiment 28: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.
Embodiment 29: The method of the previous embodiment, further comprising: at the host, executing a host application associated with a client application executing on the UE to receive the user data from the UE.
Embodiment 30: The method of the previous embodiment, further comprising: at the host, transmitting input data to the client application executing on the UE, the input data being provided by executing the host application, wherein the user data is provided by the client application in response to the input data from the host application.
Embodiment 31: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
Embodiment 32: The host of the previous embodiment, wherein the cellular network further includes a network node configured to communicate with the UE to transmit the user data from the UE to the host.
Embodiment 33: The host of the previous 2 embodiments, wherein: the processing circuitry of the host is configured to execute a host application, thereby providing the user data; and the host application is configured to interact with a client application executing on the UE, the client application being associated with the host application.
Embodiment 34: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.
Embodiment 35: The method of the previous embodiment, further comprising: at the host, executing a host application associated with a client application executing on the UE to receive the user data from the UE.
Embodiment 36: The method of the previous embodiment, further comprising: at the host, transmitting input data to the client application executing on the UE, the input data being provided by executing the host application, wherein the user data is provided by the client application in response to the input data from the host application.
Embodiment 37: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
Embodiment 38: The host of the previous embodiment, wherein: the processing circuitry of the host is configured to execute a host application that provides the user data; and the UE comprises processing circuitry configured to execute a client application associated with the host application to receive the transmission of user data from the host.
Embodiment 39: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.
Embodiment 40: The method of the previous embodiment, further comprising, at the network node, transmitting the user data provided by the host for the UE.
Embodiment 41: The method of any of the previous 2 embodiments, wherein the user data is provided at the host by executing a host application that interacts with a client application executing on the UE, the client application being associated with the host application.
Embodiment 42: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
Embodiment 43: The communication system of the previous embodiment, further comprising: the network node; and/or the user equipment.
Embodiment 44: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
Embodiment 45: The host of the previous 2 embodiments, wherein: the processing circuitry of the host is configured to execute a host application, thereby providing the user data; and the host application is configured to interact with a client application executing on the UE, the client application being associated with the host application.
Embodiment 46: The host of the any of the previous 2 embodiments, wherein the initiating receipt of the user data comprises requesting the user data.
Embodiment 47: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.
Embodiment 48: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving from a network node a configuration of a first time advance group (TAG), identity (ID), and a second TAG ID, and a first control resource set (CORESET), with a first CORESET pool index value and a second CORESET with a second CORESET pool index value in a serving cell;
receiving from the network node a request in the serving cell to transmit a Physical Random Access Channel (PRACH), preamble, wherein the request comprises a PRACH preamble index associated to the PRACH preamble, information about a downlink reference signal (RS), and information about a Physical Cell Identity (PCI), associated with the downlink RS;
determining based on the information about the downlink RS and the information about the PCI comprised in the request, a transmit power for transmission of the PRACH preamble; and
transmitting the PRACH preamble according to the determined transmit power.

2. The method of claim 1, wherein the request is carried in Physical Downlink Control Channel (PDCCH).

3. The method of claim 1, wherein the request is a PDCCH order carried in a Downlink Control Information (DCI), format.

4. The method of claim 1, wherein the first TAG ID is different than the second TAG ID, and the first CORESET pool index value is different than the second CORESET pool index value.

5. The method of claim 1, wherein the downlink RS is a Synchronization Reference Signal (SS), SS, and Physical Broadcast Channel (PBCH) block (SSB).

6. The method of claim 1, wherein the PCI is a PCI of the serving cell or a PCI different than the PCI of the serving cell.

7. The method of claim 1, wherein the information about the PCI associated with the downlink RS indicates the PCI, and the downlink RS is associated to the PCI indicated by the information about the PCI comprised in the request.

8. The method of claim 1, further comprising receiving, prior to receiving the request, a configuration of the downlink RS and a transmit power of the downlink RS.

9. The method of claim 1, wherein the information about the downlink RS comprises an index of the downlink RS.

10. The method of claim 1, wherein the information about the PCI comprises an indication indicating whether the PCI is an PCI of the serving cell or an PCI different than the PCI of the serving cell.

11. The method of claim 1, wherein the request is received in a DCI in one of the first and the second CORESETs.

12. The method of claim 1, wherein:
the request is a PDCCH order carried in a Downlink Control Information (DCI), format;
the downlink RS is a Synchronization Reference Signal (SS), and Physical Broadcast Channel (PBCH), block (SSB),
the information about the downlink RS is an SSB index of the SSB;
the information about the PCI is the PCI; and
determining the transmit power for transmission of the PRACH preamble comprises determining the spatial Tx filter and the transmit power for transmission of the PRACH preamble based on the SSB index and the PCI comprised in the PDCCH order.

13. The method of claim 1, wherein the method further comprises determining a spatial filter for transmission of the PRACH preamble based on the downlink RS and the PCI.

14. The method of claim 13, wherein the spatial filter is a spatial filter used in receiving the downlink RSI.

15. The method of claim 1, wherein determining the transmit power for transmission of the PRACH preamble comprises:
calculating a pathloss as a difference between a transmit power of the downlink RS and a Reference Signal Received Power (RSRP), measured based on the downlink RS; and
determining the transmit power for transmission of the PRACH preamble based on the calculated pathloss.

16. The method of claim 1, wherein the request is received on the serving cell of the UE.

17. The method of claim 1, further comprising receiving configuration information that configures the UE with one or more of:
a first set of downlink RSs with a first transmit power associated to a first PCI, where the first PCI is a PCI of the serving cell;
a first PRACH configuration and a first set of PRACH preambles associated to the first PCI;
a list of Transmission Configuration Indicator (TCI), states;
a second set of downlink RSs with a second transmit power associated to a second PCI; and
a second PRACH configuration and a second set of PRACH preambles associated to the second PCI.

18. The method of claim 17, wherein the first PCI and the second PCI are different.

19. The method of claim 17, wherein the PCI indicated in the request is one of the first and the second PCIs.

20. The method of claim 17, wherein the PRACH preamble indicated in the request is one of the first set of PRACH preambles if the first PCI is indicated in the request, and one of the second set of PRACH preambles if the second PCI is indicated in the request.

21. The method of claim 17, wherein the downlink RS indicated in the request is one of the first set of downlink RSs if the first PCI is indicated in the request and one of the second set of downlink RSs if the second PCI is indicated in the request.

22-25. (canceled)

26. A User Equipment (UE), comprising:
a communication interface comprising a transmitter and a receiver; and
processing circuitry associated with the communication interface, the processing circuitry configured to cause the UE to:
receive from a network node a configuration of a first time advance group (TAG), identity (ID), and a second TAG ID, and a first control resource set (CORESET), with a first CORESET pool index value and a second CORESET with a second CORESET pool index value in a serving cell;
receive from the network node a request in the serving cell to transmit a Physical Random Access Channel (PRACH), preamble, wherein the request comprises a PRACH preamble index associated to the PRACH preamble, information about a downlink reference signal (RS), and information about a Physical Cell Identity (PCI), associated with the downlink RS;
determine based on the information about the downlink RS and the information about the PCI comprised in the request, a transmit power for transmission of the PRACH preamble; and
transmit the PRACH preamble according to the determined transmit power.

27. (canceled)

28. A method performed by a network node, the method comprising:
transmitting to a User Equipment (UE), a configuration of a first time advance group (TAG), identity (ID), and a second TAG ID, and a first control resource set (CORESET), with a first CORESET pool index value and a second CORESET with a second CORESET pool index value in a serving cell; and
transmitting to the UE a request in the serving cell to transmit a Physical Random Access Channel (PRACH), preamble, wherein the request comprises a PRACH preamble index associated to the PRACH preamble, information about a downlink reference signal (RS), and information about a Physical Cell Identity (PCI), associated with the downlink RS.

29. (canceled)

30. A network node comprising processing circuitry configured to cause the network node to:
transmit to a User Equipment (UE), a configuration of a first time advance group (TAG), identity (ID), and a second TAG ID, and a first control resource set (CORESET), with a first CORESET pool index value and a second CORESET with a second CORESET pool index value in a serving cell; and
transmit to the UE a request in the serving cell to transmit a Physical Random Access Channel (PRACH), preamble, wherein the request comprises a PRACH preamble index associated to the PRACH preamble, information about a downlink reference signal (RS), and information about a Physical Cell Identity (PCI), associated with the downlink RS.
